(19) United States
(12) Patent Application Publication
(10) Pub. No.: US 2021/0012026 A1
(43) Pub. Date: Jan. 14, 2021

(54) TOKENIZATION SYSTEM FOR CUSTOMER DATA IN AUDIO OR VIDEO

(71) Applicant: Capital One Services, LLC, McLean, VA (US)

(72) Inventors: Kenneth TAYLOR, Champaign, IL (US); Austin Grant WALTERS, Savoy, IL (US); Mark Louis WATSON, Urbana, IL (US); Anh TRUONG, Champaign, IL (US); Jeremy Edward GOODSITT, Champaign, IL (US); Vincent PHAM, Champaign, IL (US); Fardin ABDI TAGHI ABAD, Champaign, IL (US); Reza FARIVAR, Champaign, IL (US); Kate KEY, Effingham, IL (US)

(73) Assignee: Capital One Services, LLC, McLean, VA (US)

(21) Appl. No.: 16/504,822

(22) Filed: Jul. 8, 2019

(51) Int. Cl. G06F 21/62; G06Q 20/10; G06Q 20/40; G06N 20/00

(52) U.S. Cl. CPC G06F 21/6245; G06N 20/00; G06Q 20/4014; G06Q 20/1085

(57) ABSTRACT

Various embodiments are directed to a system for identifying personally identifiable information (PII) in digital media content, such as audio files, videos, images, etc. and providing such content with one or more portions thereof appropriately tokenized based on an access level of the user requesting the content. The PII may be detected in the digital media content using a machine learning model or a classification model.

### BACKGROUND

Information sensitivity relates to the control of access to information or knowledge that might result in the loss of confidentiality, security, or advantage when disclosed to unauthorized persons. During business transactions, for example, customers of a business may provide the business various types of sensitive personal or private information, which may be recorded in digital audio and/or video format. For instance, an audio recording between a customer and a customer care representative may contain the customer's social security number, birthdate, mother's maiden name, etc. during the verification process of the user. In another instance, a video recording of customers utilizing an automated teller machine (ATM) may contain an image of the customer's credit card, images of the customer entering a PIN number, the customer's face, the customer's vehicle plate number, etc.

For compliance and other purposes, business employees may typically have varying levels of access related to customer personal or private information. Because the recordings may contain sensitive customer information, an employee who does not have the requisite clearance level may be prevented from viewing, listening to, or otherwise using the information contained in the recordings (even if the information does not pertain to private or personal customer information).

Accordingly, there is a need for universal employee access of the digital audio and/or video recordings of customer information without violating set compliance procedures or revealing any private or personal customer information.

### SUMMARY

Various embodiments are generally directed to a system for identifying personally identifiable information (PII) in digital media content, such as audio files, videos, images, etc. and providing such content with one or more portions thereof appropriately tokenized based on an access level of the user requesting the content. The PII may be detected in the digital media content using a machine learning model or a classification model. Moreover, each token may include a token identifier, which may at least identify the type of PII that the token is masking and the access level required to otherwise view, use, or access the PII.

### BRIEF DESCRIPTION OF THE DRAWINGS

FIG. 1 illustrates an example tokenization platform in accordance with one or more embodiments.

FIG. 2 illustrates an example machine learning model for personally identifiable information (PII) detection and tokenization in accordance with one or more embodiments.

FIG. 3 illustrates an example PII detection and tokenization of an audio recording in accordance with one or more embodiments.

FIG. 4 illustrates an example PII detection and tokenization of a video recording in accordance with one or more embodiments.

FIG. 5 illustrates an example access level classification for at least one token in accordance with one or more embodiments.

FIG. 6 illustrates an example flow diagram in accordance with one or more embodiments.

FIG. 7 illustrates an example computing architecture of a computing device in accordance with one or more embodiments.

FIG. 8 illustrates an example communications architecture in accordance with one or more embodiments.

### DETAILED DESCRIPTION

Various embodiments are generally directed to a system for at least determining personally identifiable information (PII) in digital media content, e.g., audio, video, and performing tokenization of the same such that all users may be able to view, listen, use, or otherwise access the audio or video content based on access levels.

According to embodiments, a tokenization platform may receive audio and/or video content and determine whether the content contains any PII. When the platform determines that the content contains customer PII, the tokenization platform may tokenize the PII based on, for example, the access level of the user requesting access to the content. For example, each token created during the tokenization process may include an identifier indicating at last the type of PII that was tokenized and mapping information corresponding to the PII. Thus, when the tokenization platform may reveal the PII in the audio and/or video content, if requested, based on the access level of the user requesting the content.

In examples, a machine learning algorithm may identify PII contained in the digital audio and/or video content. In further examples, the machine learning algorithm may identify the PII and also perform tokenization of the same. According to one embodiment, the machine learning algorithm may quickly scan, analyze, and identify all objects in a video recording or stream, for instance, that are commonly known to contain or associated with PII as being “likely” PII. For example, objects having a square or rectangular shape and size of a banking card, a trapezoidal shape and size of the banking card when viewed at an angle, a general shape and size of an ATM, a shape and size of a keypad on the ATM, a shape and size of a license plate, and/or a general shape and size of a person's face may be identified as likely containing PII. Moreover, any series of numbers having a predetermined length may be identified as likely PII. Any object identified as potentially containing PII may be tokenized. In another example, optical character recognition (OCR) may be performed on the object identified as containing the likely PII to further identify actual PII, which allows the PII to be tokenized on more granular level without having to over tokenize the digital media content.

In previous solutions, for example, tokenization has been an “all or nothing” approach. Thus, when digital media content retained by a business contained PII of its customers, the content was unusable since the PII could be heard or viewed by employees without proper authorization. The embodiments, examples, and aspects of the present disclosure overcome and are advantageous over the previous solutions in various ways. For example, content containing PII may be tokenized, and when the content is requested by a user, the various tokenized portions of the content may be revealed based on the access level of the user. Accordingly, regardless of the access level of the employee, the content can still be provided while keeping the PII hidden from the employee, if required. Moreover, the detection of PII in the content may be advantageously performed at different levels. For example, a quick scan of the content may reveal objects or components of the content that may likely be PII, which may be tokenized. In other examples, the likely PII may be further analyzed to identify actual PII at a granular level to achieve a more accurate application of tokenization.

Reference is now made to the drawings, where like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modification, equivalents, and alternatives within the scope of the claims.

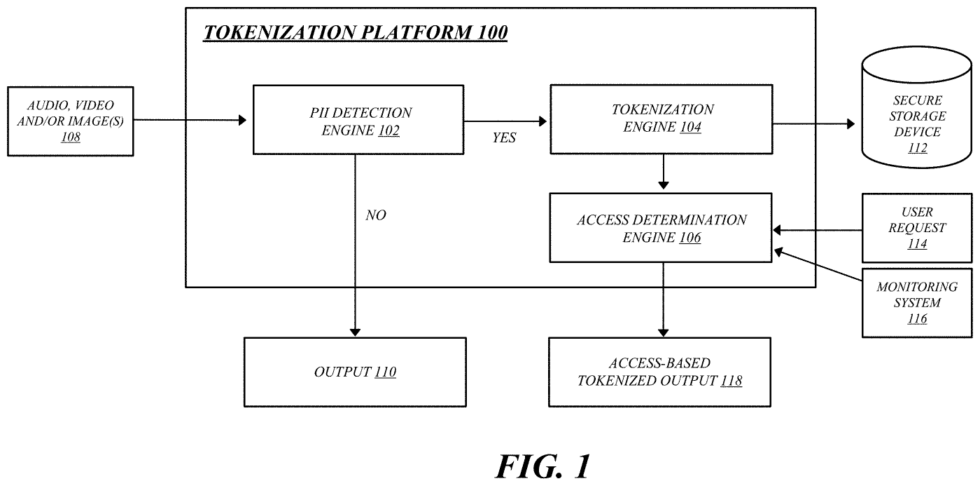

FIG. 1 illustrates an example tokenization platform 100 according to embodiments. As shown, the tokenization platform 100 may include at least a personally identifiable information (PII) detection engine 102, a tokenization engine 104, and an access determination engine 106. For example, the PII detection engine 102 may receive various types of digital media content, e.g., audio, video, and/or image(s) 108, and determine whether they contain PII. When the content does contain PII, it is passed to the tokenization engine 104. When it is determined that no PII exists, the content is provided to the user as output 110. As will be further described below, one or more machine learning algorithms may be trained and used to determine whether audio and/or video content contains PII.

The tokenization engine 104 may tokenize the PII in the content with one or more tokens. As illustrated, the PII mapping back to the one or more tokens may be stored in one or more secure storage devices or databases, such as secure storage device 112. In examples, the one or more tokens created by the tokenization engine 104 may include an identifier, which may include information about the type of PII, what portion of the content is being tokenized, mapping information, etc., as will be further described below. It may be understood that while the secure storage device 112 is arranged outside of the tokenization platform 100, it is not limited that arrangement and the secure storage device 112 may be part of or included in the tokenization platform 100.

According to embodiments, the tokenized content may be provided to the access determination engine 106 to determine whether the content is being accessed properly. As shown, for example, the access determination engine 106 may receive a user request 114 to access the digital media content. In other examples, a monitoring system 116 may alert the access determination engine 106 that a user (or users) are attempting to or being provided the content containing PII. The access determination engine 106 may identify or determine the access level(s) of the user(s) requesting the media content, and based on the access level(s), provide an access-based tokenized output 118. It may be understood that accessing the audio file, the video content, or the image includes playing, listening, viewing, watching, and/or using the audio file, the video content, or the image.

In examples, the access-based tokenized output may be different for users having different access levels. For example, and as will be further described below, when a user having a low access level requests access of the digital media content, the content may be provided with all of the PII tokenized. In another example, when a user having a higher (and requisite) access level requests access of the content, the content may be provided with one or more portions of the PII revealed or “untokenized,” as appropriate. It may be understood that the term “low access level” refers to a level of highest restriction. Moreover, the term “high access level” may be understood to refer to a level of lowest restriction and commonly associated with high level employees within a company having requisite clearances to view sensitive and personal information. The term “medium access level” may refer to a level anywhere between high and low.

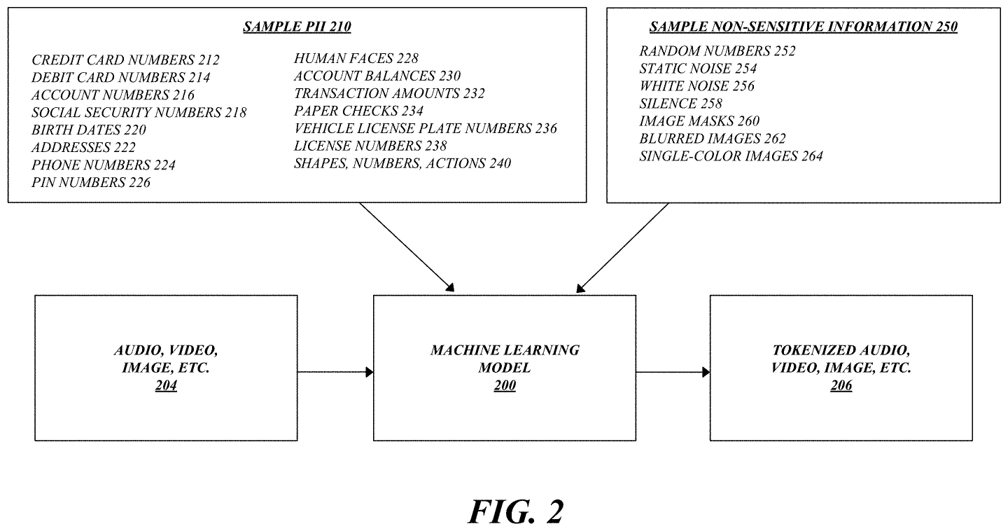

FIG. 2 illustrates an example machine learning model 200 for PII detection and tokenization according to embodiments. For example, the PII detection engine 102 described above with respect to FIG. 1 may include or incorporate the machine learning model 200. As shown, the machine learning model 200 may receive input in the form of digital media content, e.g., audio, video, and/or images 204, and may determine whether the content contains PII. The machine learning model 200, based on the determination that the content includes PII, may tokenize the PII and output a tokenized version 206 of the input digital media content.

The term “tokenized” may be understood to mean that one or more portions of the PII in the content are replaced with tokens that are mappable back to the respective one or more portions of the PII. In an alternative example, the tokenization mechanism may be a separate process and the machine learning model 200 may be configured to solely determine whether the content contains PII and to output that determination.

In examples, the machine learning model 200 may be trained using one or more training sets over one or more iterations. As shown, one example training set may include sample PII 210. The sample PII 210 may include examples of (in terms of substance and/or format) at least credit card numbers 212, debit card numbers 214, account numbers 216, social security numbers 218, birth dates 220, addresses 222, phone numbers 224, pin numbers 226, human faces 228, account balances 230, transaction amounts 232, paper checks 234, vehicle license plate numbers 236, license numbers 238, shapes, numbers, actions, etc. 240. It may be understood that the shown sample PII 210 is not an exhaustive list and not limited to the listed examples. Although not shown, sample PII 210 may also include shapes commonly associated with objects likely containing PII, such as a square shape associated with a card, a trapezoidal shape associated with a card when viewed at an angle, a series of numbers having a predefined length, a shape associated with an ATM, a shape of a key pad of the ATM, a shape of a license plate, a general shape of a face of a person, etc.

As further shown in FIG. 2, another example training set may include sample non-sensitive information 250. Upon determining that digital media content contains PII, the machine learning model 200 may replace one or more portions of the PII with various non-sensitive information as tokens. For instance, the list of sample non-sensitive information 250 may include at least random numbers 252, static noise 254, white noise 256, silence 258, image masks 260, blurred images 262, and single-color images 264. It may again be understood that the shown sample non-sensitive information 250 is not an exhaustive list and not limited to the listed examples. For example, the non-sensitive information 250 may also include a voice-over or a similar type of narration indicating that the information being replaced is “sensitive data” or the like. Moreover, it may be understood that the non-sensitive information, e.g., tokens, may have no meaning or value that is exploitable by an unauthorized user.

Moreover, it may be understood that the machine learning model may be any suitable model, such as a classification model, a logistic regression model, a decision tree model, a random forest model, a Bayes model, etc. based at least in part on a convolutional neural network (CNN) algorithm, a recurrent neural network (RNN) algorithm, or a hierarchical attention network (HAN) algorithm, and/or the like.

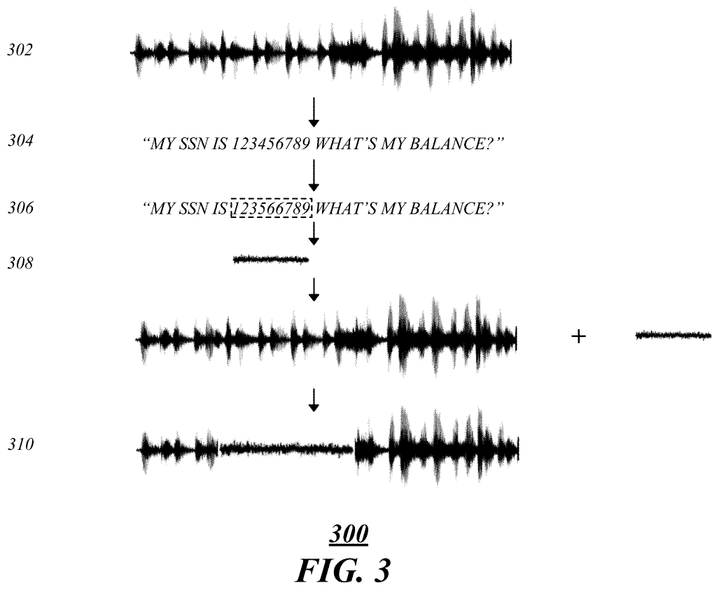

FIG. 3 illustrates an example PII detection and tokenization 300 of an audio recording 302 according to embodiments. By way of example, the audio recording 302 may include portions of a conversation between a customer and a customer service representative of a banking company. As shown, analysis and processing may be performed on the audio recording 302 so as to produce a speech-to-text string 304, which may recite “My SSN is 123456789 what's my balance?” Further analysis 306 may be performed on the speech-to-text string 304 to identify any PII therein. As described above, the machine learning model 300 of FIG. 3 or the PII detection engine 102 of FIG. 1 may perform the PII identification. Based on the analysis 306, the number string 123456789 in the speech-to-text string 304 is identified as likely being PII.

Upon identifying likely PII, a mask 308 may be created based on the PII and the time coding of the text as mapped to the audio stream of the audio recording 302. In examples, the mask 308 may be white noise or any other suitable noises that block out the social security number in the audio recording. The mask 308 may be considered a token (or tokens) that has no exploitable meaning or value.

Once the mask 308 (e.g., token) has been created, it may be combined with the original audio recording 302 to obtain a “tokenized” audio recording 310, and, as shown, the portion where the actual verbalization of the customer's social security number is replaced with the mask 308. Accordingly, the PII in the audio recording 302 is replaced with a token. In examples, the tokenized audio recording 310 may be stored separately from the original audio recording 302. Moreover, as described above, the PII, e.g., the social security number of the customer, may be stored in at least one secure storage device or database.

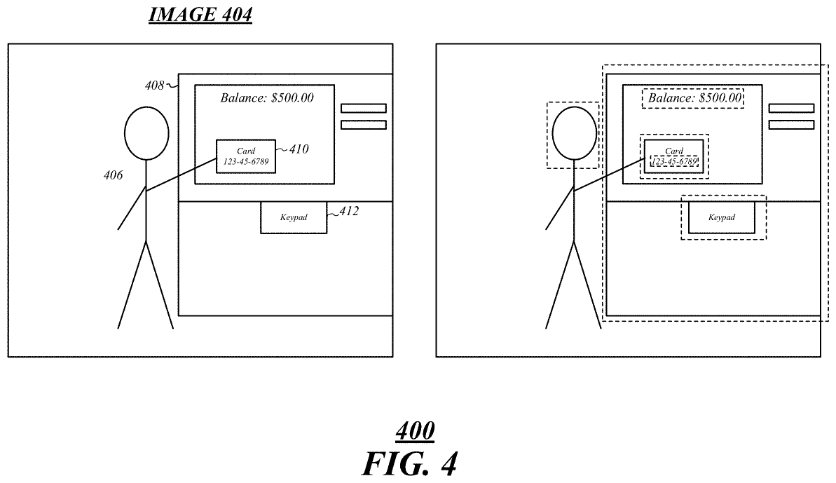

FIG. 4 illustrates an example PII detection and tokenization 400 of a video recording according to embodiments. For example, the video recording may be a recording of a customer withdrawing money from an ATM. One or more images, or a series of consecutive images, derived from the video recording or video stream may be analyzed to identify any potential PII of the customer.

As shown, image 404 may include a customer 406 near or adjacent to an ATM 408. The customer 406 may insert a banking card 410 into the ATM and enter a PIN via an ATM keypad 412 in order to access an associated account. The account balance may be displayed on an ATM display screen, e.g., $500.

In embodiments, a machine learning model (e.g., machine learning model 200) or a PII detection engine (e.g., PII detection engine 102) may quickly scan the image for any shapes, numbers, actions, colors, etc. that may be indicative of PII or an object containing PII. For example, the shapes, numbers, etc. may include at least a square shape (or generally a square or rectangular shape) associated with a card, a trapezoidal shape (or generally a trapezoidal shape) associated with a card at a specific angle, a series of numbers having a predefined length, a shape (or a general shape) associated with an ATM, a shape (or a general shape) of a keypad of an ATM, a shape (or a general shape) of a license plate of a vehicle, a shape (or general shape) of a person's face may be automatically and dynamically identified as potentially being PII or likely PII without having to assess whether content therein in the shapes actually contain PII. In further embodiments, however, the shapes may be further assessed at a granular level to determine whether they contain actual PII.

As shown in FIG. 4, at least four separate objects in image 404 may be identified as likely PII, all of which have been outlined by a dashed box e.g., the oval or circular shape of the face of the customer 406, the general square or rectangular shape of the ATM 408, the general rectangular shape of the banking card 410, and the rectangular shape of ATM keypad 412. For instance, identifying the ATM keypad 412 as potentially revealing PII may be important in instances where the customer 406 is entering a PIN via the keypad 412 and is captured in the video recording. In some examples, the identified objects may be entirely tokenized, e.g., replaced with random numbers, image masks, blurred images, a single-color image, etc.

In other examples, the identified objects likely associated with PII or containing PII may be further analyzed to determine whether they actually contain PII. For instance, an optical character recognition (OCR) may be performed on the objects identified as likely being PII, and based on the OCR, actual PII may be detected in the objects. For instance, OCR may be performed on the identified shape corresponding to the ATM 408, which may reveal that the ATM display screen is displaying an account balance of $500. Thus, the account balance information may be tokenized, and thus, removed from the video recording. Moreover, OCR may be performed on the shape corresponding to the banking card 410, which may reveal a unique card number, e.g., 123-45-6789. The card number may also be tokenized and removed from the video recording. By performing a more granular analysis on the likely PII, for example, only the actual PII may be removed while keeping the overall image and shape of associated object.

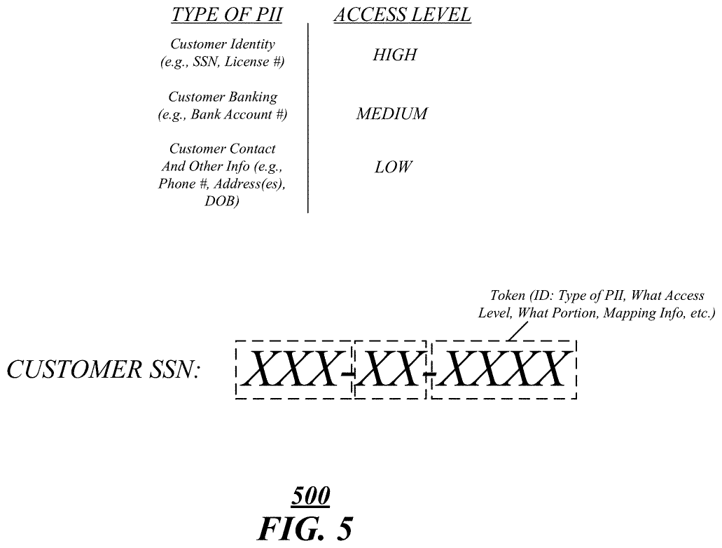

FIG. 5 illustrates an example access level classification for one or more tokens according to embodiments. In examples, different access levels may be assigned to different types of PIIs. For instance, any information related to or revealing personal or private information associated with a customer's identity, e.g., social security number, driver's license number, etc., may require the user, such as a banking employee (as described above), requesting it to have a high access level. Banking related information, such as a bank account number, credit card number, debit card number, PIN numbers, etc. may require the user to have a medium access level. All other types of information, such as customer contact information, e.g., phone numbers, addresses, date of birth, etc. may require the user to have only a low access level.

When PII or portion thereof is tokenized, the token replacing the PII (or portion of the PII) may include an identifier (ID) that specifies at least the type of PII being tokenized, the access level corresponding to the type of PII (e.g., the access level required to properly access, reveal, or untokenized the PII), what portion of the PII the token is associated with (if a portion of the PII is being tokenized), mapping information back to the PII in the event the PII is to be retrieved from the secure storage device and provided (e.g., revealed) to the user requesting or accessing it, and the like. It may be understood that the tokenization process, including the creation of the token ID, may be performed by a tokenization engine (e.g., tokenization engine 104 of FIG. 1).

As shown, for example, a customer's social security number may be tokenized by three separate tokens, which are represented by the three dashed boxes. The token located on the right end of number string may include an ID that specifies at least that (i) the type of PII is a social security number belonging to a specific customer, (ii) the PII corresponds to a high access level, (iii) it is the third portion of a total of three portions of the PII, and mapping information back to the PII (the four numbers of the social security number) stored in one or more secure storage devices.

According to embodiments, a user, such as a banking employee, may request access to content that contains the customer's social security number. Based on the access level of the user requesting such content, one or more tokenized portions may be revealed or provided to the user along with the content. For example, if the user has a high access level, an access determination engine (e.g., access determination engine 118 of FIG. 1) may determine that the customer's social security number may be untokenized, revealed, or provided to the user in its entirety based on the information contained in the token ID and predetermined rules, e.g., the entire social security number may be revealed or provided to users having high access levels. In another example, if the user has a medium access level, the access determination engine may provide the content with only the last four digits of the social security number revealed or untokenized. For low access level users, the entire social security number may remain tokenized when the content is provided.

Accordingly, the higher the access level of the user, the more portions of the PII may be revealed, e.g., the entire PII may be revealed to the user having the highest access level. Moreover, it may be understood that predetermined or predefined threshold access levels may be set for certain types of PII, e.g., PII or portions thereof may be revealed if the user has an access level of medium and above. As set forth above, it may be understood that the term “low access level” refers to a level of highest restriction, the term “high access level” may be understood to refer to a level of lowest restriction and commonly associated with high level employees within a company having requisite clearances to view sensitive and personal information, and the term “medium access level” may refer to a level anywhere between high and low.

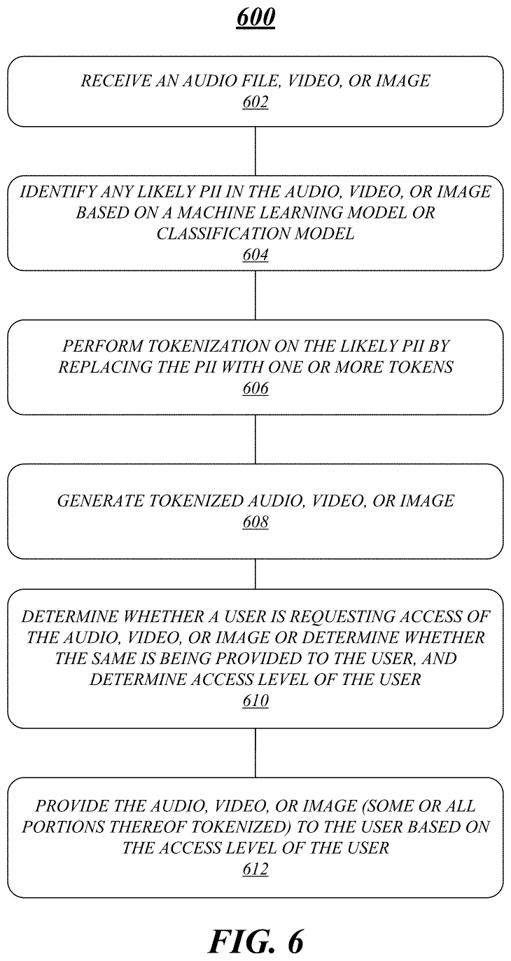

FIG. 6 illustrates an example flow diagram 600 according to one or more embodiments. The flow diagram 600 may be related to the detection and tokenization of PII. It may be understood that the features associated with the illustrated blocks may be performed or executed by one or more computing devices and/or processing circuitry contained therein that can run, support, execute a tokenization platform, such as the one illustrated in FIG. 1.

At block 602, digital media content, such as an audio file, a video, or an image may be received, for example, by the tokenization platform. In other examples, the tokenization platform may monitor system activities and actively search for the digital media content.

At block 604, any likely PII in the audio file, video, or the image may be identified. As described above, the PII may be identified by a machine learning model or a classification model, which may be trained using one or more data sets that include various types of sample PII, patterns typically found in PII, and/or typical formats associated with PIIs (e.g., social security numbers are generally nine digits long in the format of XXX-XX-XXXX). Thus, in an audio recording, the audio may be converted to speech, which may be analyzed by the model to identify any PII, as set forth above. In further examples, the models may be trained to quickly identify anything, e.g., series of numbers, shapes, colors, patterns, arrangements, persons, etc., in the digital media content that may likely be PII. Upon determination of the likely PII, further analysis may be performed thereon, such as performing OCR on the likely PII, to determine content that is indeed PII (which, in some examples, may be the entire likely PII). Thus, for instance, if a rectangular object having the general shape and size of an ATM is detected as likely being PII in a video recording (or in an image of a video recording), OCR may be performed on that rectangular object identified as likely PII to identify real PII, such as a user's account balance, account number, or other types of account-related information.

At block 606, one or more portions of the likely PII (or the actual PII) may be tokenized via one or more tokens. The tokens, for example, may be any type of masking information that has no exploitable meaning or value. Each token, as described above, may include a token identifier (ID) that specifies different types of information, such as the type of PII that it is masking, who the PII can or cannot be revealed to, mapping information back to the PII, etc. At block 608, a tokenized audio, video, or image is generated.

At block 610, it is determined whether access to the digital media content is being requested by a user, or whether the digital media content is being provided to the user. In either instance, the access level of the user ultimately gaining access to the digital media content may be determined in order to further determine what portions of the content that are tokenized can be revealed to the user.

At block 612, if it is determined that the user access level does not meet a predetermined threshold level (e.g., medium), then none of the tokenized portions of the digital media content are revealed to the user. If the user access level meets the predetermined threshold level, then some or all tokenized portions may be revealed. For instance, if the user access level is high, then all the PII may be revealed. If medium, then only some portions, in accordance with the information specified in the token ID, may be revealed, e.g., customer banking information such as an account number.

It may be understood that the blocks illustrated in FIG. 6 are not limited to any specific order. One or more of the blocks may be performed or executed simultaneously or near simultaneously.

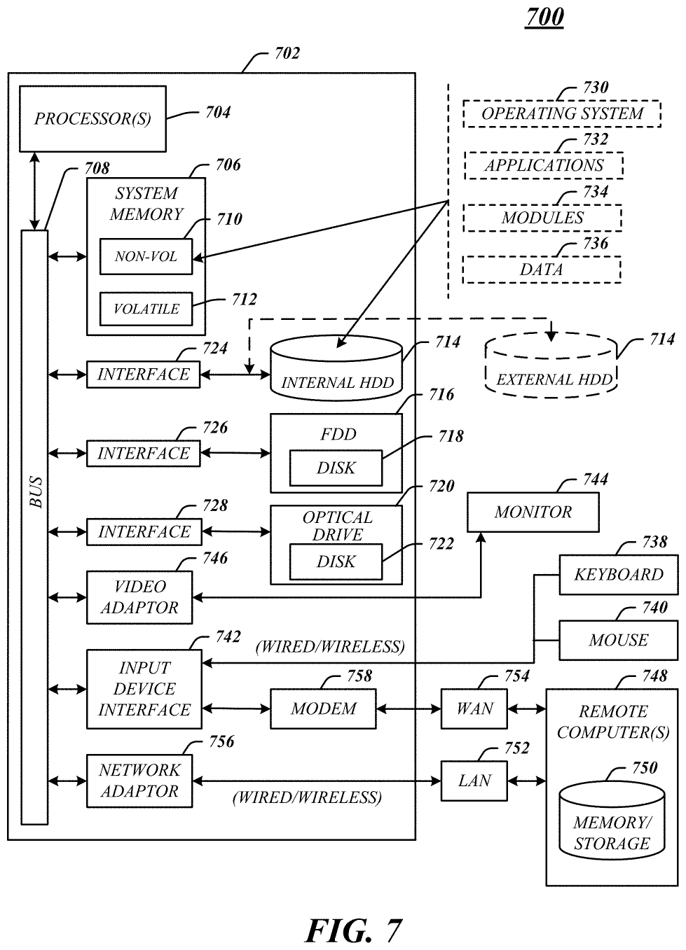

FIG. 7 illustrates an embodiment of an exemplary computing architecture 700, e.g., of a computing device, such as a desktop computer, laptop, tablet computer, mobile computer, smartphone, etc., suitable for implementing various embodiments as previously described. In one embodiment, the computing architecture 700 may include or be implemented as part of a system, which will be further described below. In examples, one or more computing devices and the processing circuitries thereof may be configured to at least run, execute, support, or provide the tokenization platform, e.g., tokenization platform 100 and related functionalities (via, for example, backed server computers).

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes processor 704, a system memory 706 and a system bus 708. The processor 704 can be any of various commercially available processors, processing circuitry, central processing unit (CPU), a dedicated processor, a field-programmable gate array (FPGA), etc.

The system bus 708 provides an interface for system components including, but not limited to, the system memory 706 to the processor 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 800.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 704 through an input device interface 742 that is coupled to the system bus 708 but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754 or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

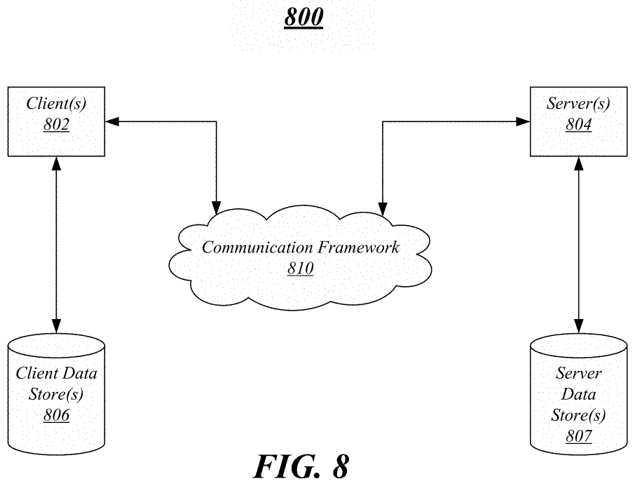

FIG. 8 is a block diagram depicting an exemplary communications architecture 800 suitable for implementing various embodiments. For example, one or more computing devices may communicate with each other via a communications framework, such as a network. At least a first computing device connected to the network may be one or more server computers, which may be implemented as a back-end server or a cloud-computing server, which may run the tokenization platform described herein, e.g., tokenization platform 100, and perform all related functionalities. At least a second computing device connected to the network may be a user computing device, such as a mobile device (e.g., laptop, smartphone, tablet computer, etc.) or any other suitable computing device that belongs to the end-user.

The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The one or more clients 802 and the servers 804 are operatively connected to one or more respective client data stores 806 and server data stores 807 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose and may be selectively activated or reconfigured by a computer program stored in the computer. The procedures presented herein are not inherently related to a particular computer or other apparatus. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system comprising:
one or more computing devices, wherein the one or more computing devices comprises:
memory to store instructions; and
processing circuitry, coupled with the memory, operable to execute the instructions, that when executed, cause the processing circuitry to:
receive an audio file, a video, or an image;
identify likely personally identifiable information (PII) in the audio file, the video, or the image, wherein the identification of the likely PII is performed by a machine learning model or a classification model;
perform tokenization of a first portion and a second portion of the likely PII by replacing the first portion of the likely PII with a first token and replacing the second portion with a second token, wherein the first and second tokens comprise non-sensitive information;
generate a tokenized audio file, a tokenized video, or a tokenized image based on the first and second tokens;
determine whether (i) a user is requesting access to the audio file, the video, or the image or (ii) the audio file, the video, or the image is being provided to the user;
determine an access level of the user; and
(i) in response to the determination that the access level of the user meets a predefined access threshold level, provide the first token and the second portion of the likely PII in the tokenized audio file, the tokenized video, or the tokenized image such that the first portion of the likely PII is tokenized by the first token and the second portion of the likely PII is revealed to the user and (ii) in response to the determination that the access level of the user exceeds the predefined access threshold level, provide the first and second portions of the likely PII in the tokenized audio file, the tokenized video, or the tokenized image such that the first and second portions of the likely PII are revealed to the user, and
wherein the first token includes a first token identifier indicating that the first portion is disclosable only if the user exceeds the predefined access threshold level, and
wherein the second token includes a second token identifier indicating that the second portion is disclosable only if the user meets or exceeds the predefined access threshold level.

2. The system of claim 1, wherein the processing circuitry is further caused to store the likely PII in one or more secure databases or one or more secure storage devices.

3. The system of claim 1, wherein the access to the audio file, the video, or the image comprises playing, listening, viewing, and/or watching the audio file, the video, or the image.

4. (canceled)

5. The system of claim 1, wherein the token identifier further includes one or more of the following information: type of PII, what portion of the PII the token is concealing, and mapping information back to the respective portion of the PII.

6. The system of claim 1, wherein the non-sensitive information is one or more of the following: (i) a plurality of random numbers, (ii) static noise, (iii) white noise, (iv) silence, (v) an image mask, (vi) a blurred image, (vii) a single-color image, and (viii) a voice-over.

7. The system of claim 1, wherein the likely PII includes one or more of the following: (i) a credit card number, (ii) a debit card number, (iii) an account number, (iv) a social security number, (v) a birthdate, (vi) an address, (vii) a phone number, (viii) a pin number, (ix) a customer face, (x) an account balance, (xi) one or more transaction amounts, (xii) a paper check, (xiii) a vehicle license plate number, and (xiv) a license number.

8. The system of claim 1, wherein the predefined access threshold level includes a high access level, a medium access level, and/or a low access level.

9. The system of claim 5, wherein the one or more portions of the tokenized audio file, the tokenized video, or the tokenized image are untokenized based at least in part on the processing circuitry to:
perform analysis on the token identifier in each of the one or more tokens; and
compare the determined access level of the user to the requisite access level required to access or reveal the token specified in the token identifier.

10. The system of claim 1, wherein an entire, untokenized version of the audio file, the video, or the image is accessible to the user having a highest security access level.

11. The system of claim 1, wherein the machine learning algorithm or the classification model is trained using sample PII and/or sample PII formatting.

12. The system of claim 1, wherein the sample PII and/or the sample PII formatting comprises: (i) a credit card number, (ii) a debit card number, (iii) an account number, (iv) a social security number, (v) a birthdate, (vi) an address, (vii) a phone number, (viii) a pin number, (ix) a customer face, (x) an account balance, (xi) one or more transaction amounts, (xii) a paper check, (xiii) a vehicle license plate number, and (xiv) a license number; and
further comprises any object, shape, number, and/or action indicative of PII including one or more of the following: (i) a square shape associated with a card, (ii) a trapezoidal shape associated with a card when viewed at an angle, (iii) a series of numbers having a predefined length, (iv) a shape associated with an automated teller machine (ATM), (v) a shape of a key pad of the ATM, (vii) a shape of a license plate, and (viii) a general shape of a face of a person.

13. The system of claim 11, wherein the classification model is a logistic regression model, a decision tree model, a random forest model, or a Bayes model.

14. The system of claim 13, wherein the classification model is based on a convolutional neural network (CNN) algorithm, a recurrent neural network (RNN) algorithm, or a hierarchical attention network (HAN) algorithm.

15. The system of claim 1, wherein the processing circuitry of the one or more computing devices is further caused to:
perform optical character recognition (OCR) on the likely PII;
determine actual PII in the likely PII based on the performed OCR; and
perform tokenization on the actual PII.

16. An apparatus comprising:
memory to store instructions; and
processing circuitry, coupled with the memory, operable to execute the instructions, that when executed, cause the processing circuitry to:
receive an audio file, a video, or an image;
identify likely personally identifiable information (PII) in the audio file, the video, or the image, wherein the identification of the likely PII is performed by a machine learning model or a classification model;
perform tokenization of a first portion and a second portion of the likely PII by replacing the first portion of the likely PII with a first token and replacing the second portion with a second token, wherein the first and second tokens comprise non-sensitive information;
generate a tokenized audio file, a tokenized video, or a tokenized image based on the first and second tokens;
determine whether (i) a user is requesting access to the audio file, the video, or the image or (ii) the audio file, the video, or the image is being provided to the user;
determine an access level of the user; and
(i) in response to the determination that the access level of the user meets a predefined access threshold level, provide the first token and the second portion of the likely PII in the tokenized audio file, the tokenized video, or the tokenized image such that the first portion of the likely PII is tokenized by the first token and the second portion of the likely PII is revealed to the user and (ii) in response to the determination that the access level of the user exceeds the predefined access threshold level, provide the first and second portions of the likely PII in the tokenized audio file, the tokenized video, or the tokenized image such that the first and second portions of the likely PII are revealed to the user, and
wherein the first token includes a first token identifier indicating that the first portion is disclosable only if the user exceeds the predefined access threshold level, and
wherein the second token includes a second token identifier indicating that the second portion is disclosable only if the user meets or exceeds the predefined access threshold level.

17. The apparatus of claim 16, wherein the PII includes one or more of the following: (i) a credit card number, (ii) a debit card number, (iii) an account number, (iv) a social security number, (v) a birthdate, (vi) an address, (vii) a phone number, (viii) a pin number, (ix) a customer face, (x) an account balance, (xi) one or more transaction amounts, (xii) a paper check, (xiii) a vehicle license plate number, and (xiv) a license number.

18. The apparatus of claim 16, wherein the non-sensitive information is one or more of the following: (i) a plurality of random numbers, (ii) static noise, (iii) white noise, (iv) silence, (v) an image mask, (vi) a blurred image, (vii) a single-color image, and (viii) a voice-over.

19. A method comprising:
receiving, via one or more computing devices, an audio file, a video, or an image;
identifying, via the one or more computing devices, likely personally identifiable information (PII) in the audio file, the video, or the image, wherein the identifying of the likely PII is performed by a machine learning model or a classification model;
performing, via the one or more computing devices, tokenization of a first portion and a second portion of the likely PII by replacing the first portion of the likely PII with a first token and replacing the second portion with a second token, wherein the first and second tokens comprise non-sensitive information;
generating, via the one or more computing devices, a tokenized audio file, a tokenized video, or a tokenized image based on the first and second tokens;
determining, via the one or more computing devices, whether (i) a user is requesting access to the audio file, the video, or the image or (ii) the audio file, the video, or the image is being provided to the user;
determining, via the one or more computing devices, an access level of the user; and
(i) in response to the determining that the access level of the user meets a predefined access threshold level, providing the first token and the second portion of the likely PII in the tokenized audio file, the tokenized video, or the tokenized image such that the first portion of the likely PII is tokenized by the first token and the second portion of the likely PII is revealed to the user and (ii) in response to the determining that the access level of the user exceeds the predefined access threshold level, providing the first and second portions of the likely PII in the tokenized audio file, the tokenized video, or the tokenized image such that the first and second portions of the likely PII are revealed to the user, and
wherein the first token includes a first token identifier indicating that the first portion is disclosable only if the user exceeds the predefined access threshold level, and
wherein the second token includes a second token identifier indicating that the second portion is disclosable only if the user meets or exceeds the predefined access threshold level.

20. (canceled)
